(19) United States
(12) Patent Application Publication
(10) Pub. No.: US 2012/0242971 A1
(43) Pub. Date: Sep. 27, 2012

(54) Omnidirectional Image Detection System With Range Information

(75) Inventor: Austin C. Deric, San Antonio, TX (US)

(73) Assignee: SOUTHWEST RESEARCH INSTITUTE, San Antonio, TX (US)

(21) Appl. No.: 13/071,540

(22) Filed: Mar. 25, 2011

(51) Int. Cl. G01C 3/08

(52) U.S. Cl. 356/4.01

(57) ABSTRACT

An omnidirectional image detection system, which uses a single camera to acquire distance information from dual images. In addition to the camera, an upper mirror and a lower mirror are all arranged coaxially. Both mirrors have reflective outer surfaces, symmetric about the axis, and both are generally conical in shape, with the apex toward the camera. The lower mirror (nearest the camera) is truncated at the apex and has an opening in its center that permits light from the upper mirror to pass to the camera. The camera receives an image from each mirror, and these images form a concentric dual image. The disparity between the images can be used to provide distance data or to generate a three-dimensional image.

### TECHNICAL FIELD OF THE INVENTION

This invention relates to image detection systems, and more particularly to an omnidirectional camera system that provides distance (range) information that can be used to generate three-dimensional images.

### BACKGROUND OF THE INVENTION

An optical rangefinder is an instrument used to measure the distance from the instrument to a selected point or object. A typical optical rangefinder consists of an arrangement of lenses and prisms or mirrors and at least one camera. In one common configuration, light from a target enters the optical system through two windows spaced apart, the distance between the windows being termed the base length of the rangefinder. The rangefinder operates as an angle-measuring device for solving the triangle comprising the rangefinder base length and the line from each window to the target point.

U.S. Pat. No. 4,009,960, to S. Feldman, et al, entitled “Passive Optical Rangefinder” describes an optical rangefinder that acquires a double image of the target, using two spaced mirrors. The object's range is determined by measuring displacement of the two images received by a camera.

Although radar and laser range finders have largely replaced optical range finders, there continue to be applications in which an optical image and correlated range information is desired.

### BRIEF DESCRIPTION OF THE DRAWINGS

FIG. 1 is a schematic view of the optical rangefinder.

FIG. 2 is a ray tracing of the optical paths from the upper and lower boundaries of each mirror's field of view.

FIG. 3 is similar to FIG. 2, but illustrates the rangefinder as a solid model.

FIG. 4 illustrates rangefinder implemented for field use, contained within a cylindrical housing.

FIG. 5 illustrates the field of view of the rangefinder of FIGS. 1-4.

FIG. 6 illustrates the field of view of FIG. 5, with its two images of the same object.

FIG. 7 illustrates how the distance to a target object is calculated.

### DETAILED DESCRIPTION OF THE INVENTION

The following description is of an optical rangefinder, which uses a single camera, has a 360 degree field of view, and provides distance information. The distance information makes the rangefinder capable of three-dimensional imaging. The optical rangefinder is a simple omnidirectional image detection system with no moving parts. It is most easily implemented for visible light, but embodiments for other wavelengths are also possible.

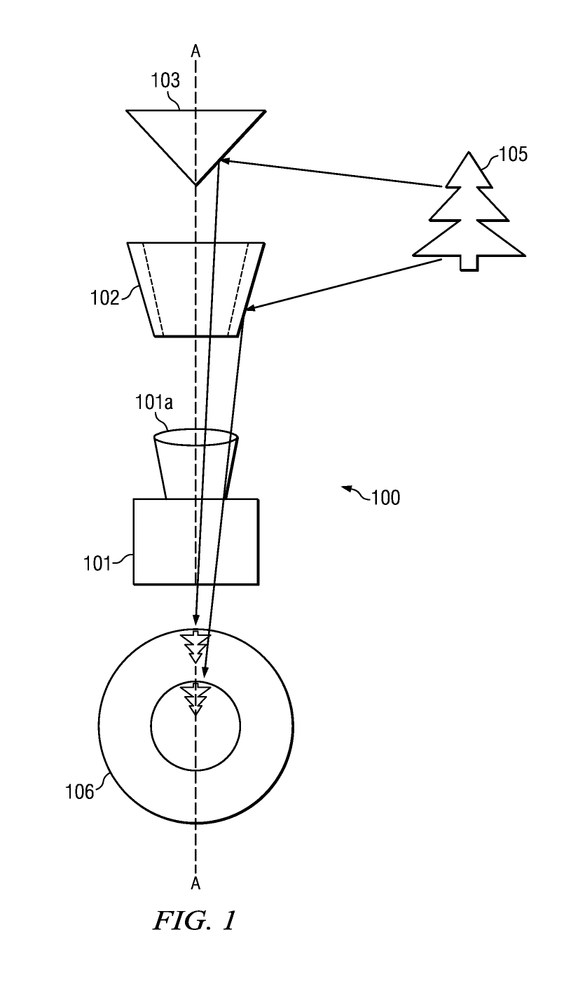

FIG. 1 is a schematic view of the optical rangefinder 100. Rangefinder 100 comprises three main elements: camera 101, a lower mirror 102 and an upper mirror 103. These elements are coaxially arranged along axis A-A.

The rangefinder's field of view includes a target 105, which is detected as two concentric images at the camera's focal plane 106. In other words, the image detected on the focal plane 106 is a dual image of the same target 105.

Lower mirror 102 is positioned along this axis, and has an outer surface that is designed to receive light from the target 105 and direct the light to camera 101. Lower mirror 102 has an opening along its vertical axis, which permits an optical path from upper mirror 103 to pass through the hole and be received by camera 101. As an alternative to having no material filling the opening, the “opening” may equivalently be any sort of transparent window with glass or other transparent material.

In general, lower mirror 102 may have various geometries, but common features are the functionality of its outer surface to direct rays from its field of view to camera 101 and the opening in the center to direct rays from the upper mirror's field of view of camera 101. Lower mirror 102 is symmetrical about the vertical axis A-A.

Upper mirror 103 receives light from target 105 and also has a surface designed to reflect rays from its field of view to camera 101. The optical path of upper mirror 103 passes through the hole in the lower mirror 102 to the camera 101. Upper mirror 103 is symmetric about the vertical axis A-A.

Because both lower mirror 102 and upper mirror 103 are symmetric about the vertical axis, each has approximately the same 360 degree field of view. The outer geometry of mirror 103 is generally conical, with the lower vertex toward camera 101. The outer geometry of mirror 102 has a generally truncated conical shape, larger than mirror 103, with its lower truncated vertex also toward camera 101. As explained below, the outer surfaces of mirrors 102 and 103 may be convex, straight, concave, or configured with some other profile, depending on desired functional parameters of the rangefinder and other design considerations.

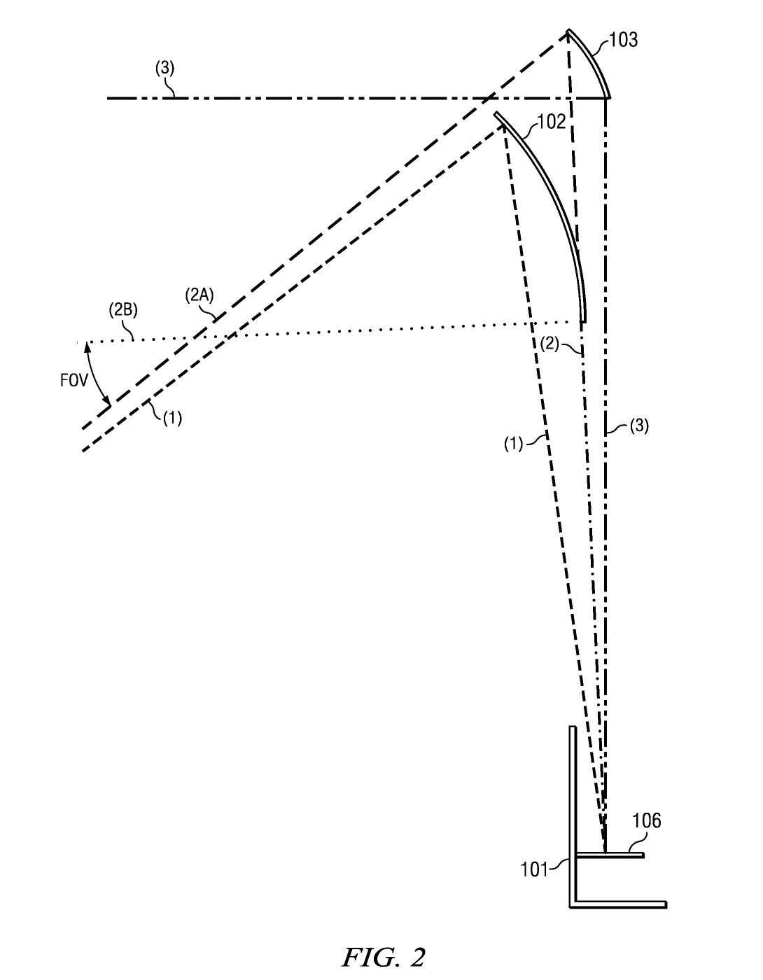

FIG. 2 is a ray tracing of the optical paths from the upper and lower boundaries of each mirror's field of view. Only the left side of the rangefinder 100 is illustrated. Upper mirror 102 and lower mirror 103 are represented by their curved outer surfaces.

Camera 101 is represented in FIG. 2 only insofar as its ability to receive light along the optical paths in each mirror's field of view. Although not explicitly shown, camera 101 may or may not have lenses to direct and/or shape light from the mirrors to focal plane 106. Camera 101 is pointed toward, i.e., its receiving lens 101a and focal plane are directed at, the apex of the upper mirror 103 and the middle of the opening in the lower mirror 102.

The image sensor of camera 101 may be implemented with commercially available CCD, CMOS or other pixel array devices. Still or motion images may be acquired and processed. Camera 101 may include memory and processing hardware or firmware, with the sophistication of the programming depending on the application. As explained below, in some applications, distance information may be processed to provide three dimensional images.

FIG. 2 is intended to illustrate the basic functional geometry of the mirror design. The ray tracing depicts three rays received at camera 101 from mirror 102 and mirror 103: an outermost ray (1), an inner ray (2) and a center ray (3). The center ray (3) coincides with the vertical axis of the rangefinder. The inner ray (2) is positioned such that each mirror focuses its reflection on a specific number of pixels on the pixel array of camera 101.

Center ray (3) reflects off the upper mirror 103 and forming the upper mirror's top ray (3). Inner ray (2) is reflected off the upper mirror 103 to form the upper mirror's bottom ray (2A). Inner ray (2) also reflects off the lower mirror 102 to form the lower mirror's top ray (2B). Outer ray (1) reflects off the lower mirror 102 to form the lower mirror's bottom ray (1).

Because mirrors 102 and 103 receive light from all directions, the field of view is omnidirectional. The “height” of the field of view is indicated by arrows in

FIG. 2. This field of view height is determined by various factors, such as the curved or angled outer surface of the mirrors.

Thus, for both mirrors 102 and 103, the curvature or angle of the outer surface is function of the desired height of the field of view, and other considerations. The mirrors' outer surface profile need not be a convex constant radius—the profile geometry of the outer surface is a function of the desired field of view, height, focal plane specs, etc. The distance between mirrors 102 and 103 is related to precision, and the distance of the mirrors from the camera 101 affects (or is affected by) the camera specifications.

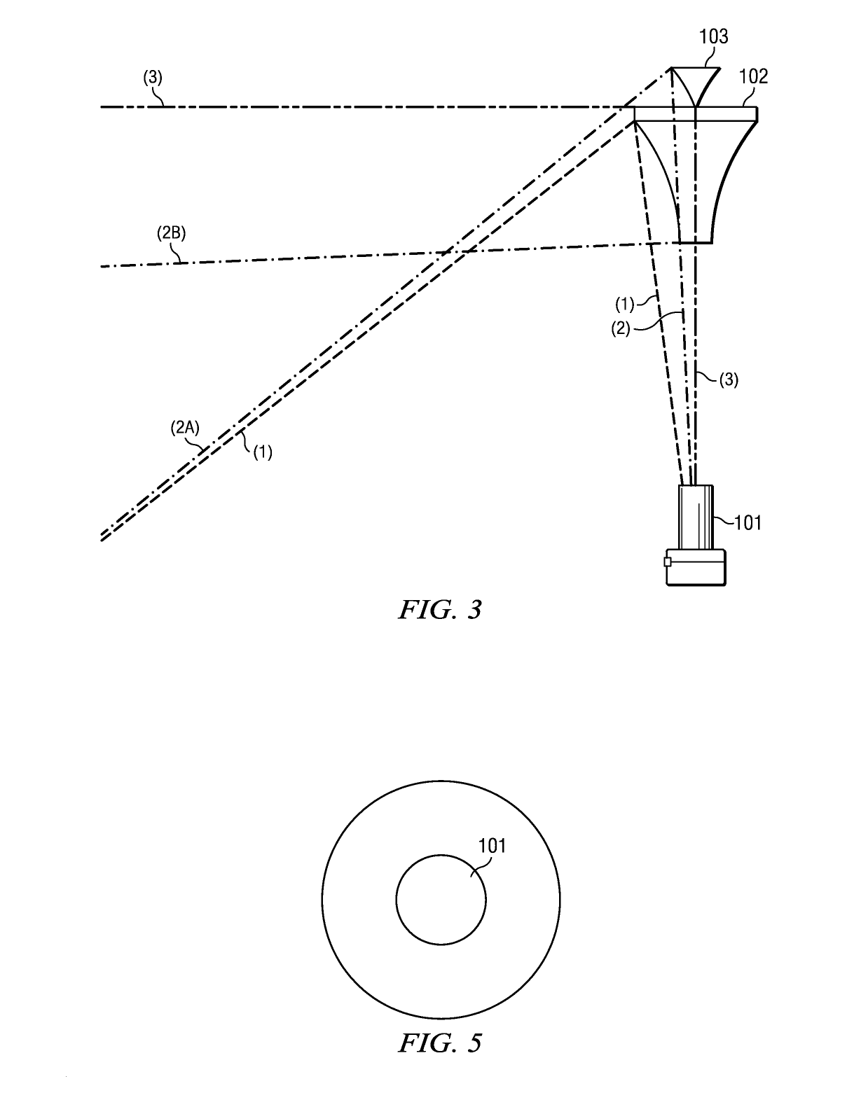

FIG. 3 is similar to FIG. 2, but illustrates rangefinder 100 as a solid model. As in all configurations, camera 101, lower mirror 102 and upper mirror 103 are coaxial. Lower mirror 102 has a hole in the middle for rays to pass through from the upper mirror 103 to the camera 101. In the example of FIG. 3, mirrors 102 and 103 have a concave constant radius curvature on their outer surfaces.

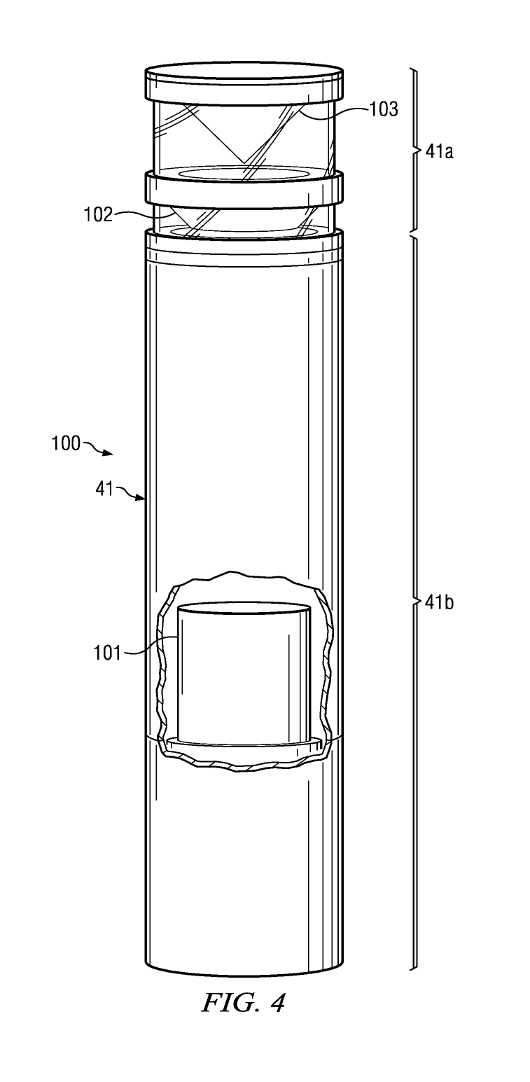

FIG. 4 illustrates rangefinder 100 implemented for field use, contained within a cylindrical housing 41. Housing 41 has an upper portion 41a that is transparent to allow visible light to reach mirrors 102 and 103. Alternatively, this portion of the rangefinder may be exposed. The lower portion 41b may be of material such as plastic or metal designed to protect camera 101, and may be opaque. For purposes of illustration, the lower portion 41b is partially open to show camera 101.

FIG. 5 illustrates the field of view of the rangefinder of FIGS. 1-4. The continuous outer surfaces of the mirrors provide a 360 degree field of view.

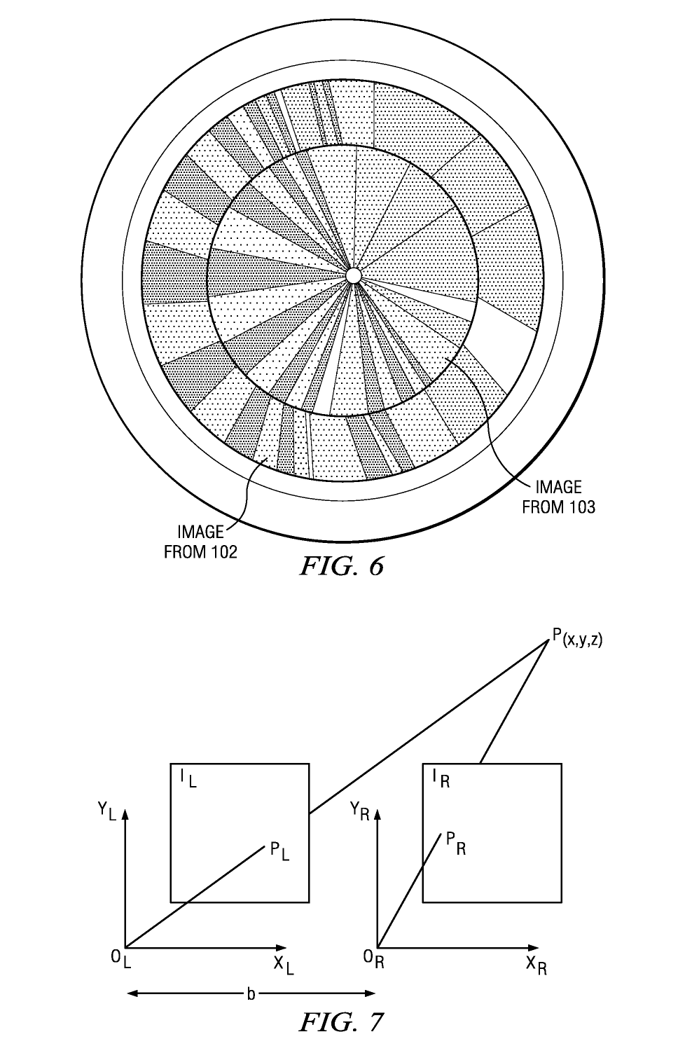

FIG. 6 illustrates an example of a concentric dual image acquired by camera 101, having the field of view of FIG. 5, with its two omnidirectional images of the same objects. The image from the upper mirror 102 is on the inside. The image from the lower mirror 103 is around the outer circumference. The same target objects are seen in the overlapping portions of the views of each mirror.

FIG. 7 provides the basic principles of how the distance to a target object may be calculated. In general, the image displacement is inversely proportional to the distance to the target. Calculations can be performed using corresponding pixel pairs from each image. Various mathematical and geometric techniques can be used to calibrate the distance between the images to real world distances.

What is claimed is:

1. An image detection system for acquiring distance information from dual images, comprising:
a camera having at least an image sensor for acquiring an image on a focal plane;
a lower mirror having a reflective outer surface, generally having the shape of a truncated cone, and further having an opening in its center;
an upper mirror having a reflective outer surface, generally conical in shape and coaxial with the focal plane;
wherein the lower mirror and upper mirror are symmetric about an axis along which the camera, lower mirror, and upper mirror are coaxially aligned; and
wherein the opening in the lower mirror permits light reflected from the upper mirror to reach the focal plane.

2. The image detection system of claim 1, wherein the image sensor is a pixel array device.

3. The image detection system of claim 1, wherein the reflective outer surface of the upper mirror or lower mirror is concave.

4. The image detection system of claim 1, wherein the reflective outer surface of the upper mirror or lower mirror is straight.

5. The image detection system of claim 1, wherein the reflective outer surface of the upper mirror or lower mirror is convex.

6. The image detection system of claim 1, wherein the dual images are visible light images.

7. The image detection system of claim 1, wherein the dual images are ultraviolet images.

8. The image detection system of claim 1, wherein the dual images are infrared images.

9. The image detection system of claim 1, wherein the outer reflective surface of the upper mirror or the lower mirror is continuous.

10. A method of acquiring distance information from dual images, comprising:
using a camera having at least an image sensor to acquire the dual images on a focal plane;
placing a lower mirror having a reflective outer surface, generally having the shape of a truncated cone, and further having an opening in its center;
placing an upper mirror having a reflective outer surface, and being generally conical in shape, coaxial with the focal plane;
wherein the lower mirror and upper mirror are symmetric about an axis along which the camera, lower mirror, and upper mirror are coaxially aligned; and
wherein the opening in the lower mirror permits light reflected from the upper mirror to reach the focal plane.

11. The method of claim 10, wherein the image sensor is a pixel array device.

12. The method of claim 10, wherein the reflective outer surface of the upper mirror or lower mirror is concave.

13. The method of claim 10, wherein the reflective outer surface of the upper mirror or lower mirror is straight.

14. The method of claim 10, wherein the reflective outer surface of the upper mirror or lower mirror is convex.

15. The method of claim 10, wherein the dual images are visible light images.

16. The method of claim 10, wherein the dual images are ultraviolet images.

17. The method of claim 10, wherein the dual images are infrared images.

18. The method of claim 10, wherein the outer reflective surface of the upper mirror or the lower mirror is continuous.

19. An image detection system for acquiring distance information from dual images, comprising:
a camera having at least an image sensor for acquiring an image on a focal plane;
a lower mirror having a reflective outer surface, generally having the shape of a truncated cone, and further having an opening in its center;
an upper mirror having a reflective outer surface, generally conical in shape and coaxial with the focal plane;
wherein the lower mirror and upper mirror are symmetric about an axis along which the camera, lower mirror, and upper mirror are coaxially aligned;
wherein the opening in the lower mirror permits light reflected from the upper mirror to reach the focal plane; and
a processing unit having hardware and memory for processing the dual image and calculating the distance to at least one object in the image.

20. The image detection system of claim 19, wherein the processor is further programmed to generate a three dimensional image from the dual images.
